(19) United States
(12) Patent Application Publication
(10) Pub. No.: US 2026/0194890 A1
(43) Pub. Date: Jul. 9, 2026

(54) SYSTEM AND METHOD FOR ROOT CAUSE ANALYSIS AND PRUNING WITH TRANSFORMERS

(71) Applicant: Robert Bosch GmbH, Stuttgart (DE)

(72) Inventors: Chen QIU, Pittsburgh, PA (US); Wan-Yi LIN, Wexford, PA (US); Tim Ralf PYCHYNSKI, Karlsruhe (DE)

(21) Appl. No.: 19/008,929

(22) Filed: Jan. 3, 2025

(51) Int. Cl. G06F 11/07

(52) U.S. Cl. CPC G05B 19/41875; G06F 11/0736; G06F 11/079

(57) ABSTRACT

A method of utilizing a machine learning model to perform root cause analysis to determine a fault that includes providing a transformer model that is trained to predict measurements of non-faulty parts, receiving, from the plurality of sensors, a first set of measurement data regarding physical characteristics of a first plurality of manufactured parts and an identification of a plurality of manufacturing stations, obtaining one or more categorical embeddings and numerical embeddings, concatenating one or more positional embeddings with the categorical numerical embedding associated with the first set of measurement data to generate a concatenation, outputting one or more embedding vectors in response to passing the concatenation at a self-attention module, and outputting a prediction utilizing a linear layer of the pre-trained transformer model and the one or more embedding vectors as input to the linear layer.

### TECHNICAL FIELD

The present disclosure relates to machine learning models, such as those that may utilize a transformer architecture utilized in manufacturing.

### BACKGROUND

GPT model is a large language model using a multi-layer Transformer architecture that includes multiple self-attention layers. The GPT model is trained to predict the next word token given the previous words tokens. It achieves success on natural language processing (NLP) tasks. But such a model may have issues as related for modeling manufacturing data, which has both categorical measurements and continuous measurements from different manufacturing sections.

DeepLift is a gradient-based approached. The gradients of the model output respect to the inputs indicates the coefficients of a neural network. Therefore, the product of the gradient and the input feature value is a good basis for developing feature attribution methods. DeepLift may compute a discrete gradient by back-propagating the difference of the model output to a baseline to the input features.

### SUMMARY

A first illustrative embodiment includes a computer-implemented method of utilizing a transformer model to perform root cause analysis on a manufacturing process, the method includes providing a pre-trained transformer model that is trained to predict measurements of non-faulty parts, receiving, from the plurality of sensors at the plurality of manufacturing stations, a first set of measurement data regarding physical characteristics of a first plurality of manufactured parts and an identification of a plurality of manufacturing stations, obtaining one or more categorical embeddings and a numerical embeddings associated with the first set of measurement data, concatenating one or more positional embeddings with the categorical embedding and the numerical embedding associated with the first set of measurement data to generate a concatenation associated with the first set of measurement data, outputting one or more embedding vectors in response to passing the utilizing the concatenation associated with the first set of measurement data at a self-attention module that includes a multi-head attention layer, and outputting a prediction associated with a second utilizing a linear layer of the pre-trained transformer model and the one or more embedding vectors as input to the linear layer.

A second illustrative embodiment includes a computer-implemented method of utilizing a pre-trained machine learning model to perform root cause analysis on a manufacturing process that includes the steps of providing a pre-trained transformer model that is trained to predict measurements of non-faulty parts, receiving, from the plurality of sensors at the plurality of manufacturing stations, a first set of measurement data regarding physical characteristics of a first plurality of manufactured parts and an identification of a plurality of manufacturing stations, for each of the plurality of manufacturing stations, the method further including obtaining one or more categorical embeddings and one or more numerical embeddings associated with the first set of measurement data, concatenating one or more positional embeddings with the categorical embedding and the numerical embedding associated with the first set of measurement data to generate a concatenation associated with the first set of measurement data, outputting one or more embedding vectors in response to passing the utilizing the concatenation associated with the first set of measurement data at a self-attention module that includes a multi-head attention layer, outputting a prediction associated with a second utilizing a linear layer of the pre-trained transformer model and the one or more embedding vectors as input to the linear layer, and outputting a contribution score associated with the first set of measurement data by computing a discrete gradient by backpropagation a difference of the linear layer output to a baseline of associated with input features.

A third illustrative embodiment includes a computer-implemented method of utilizing a machine learning model to perform root cause analysis to determine a part type causing a fault within a manufacturing setting that includes providing a transformer model that is trained to predict measurements of non-faulty parts, receiving, from the plurality of sensors at the plurality of manufacturing stations, a first set of measurement data regarding physical characteristics of a first plurality of manufactured parts and an identification of a plurality of manufacturing stations, obtaining one or more categorical embeddings and numerical embeddings associated with the first set of measurement data, concatenating one or more positional embeddings with the categorical embedding and the numerical embedding associated with the first set of measurement data to generate a concatenation associated with the first set of measurement data, outputting one or more embedding vectors in response to passing the utilizing the concatenation associated with the first set of measurement data at a self-attention module that includes a multi-head attention layer, and outputting a prediction associated with a second utilizing a linear layer of the pre-trained transformer model and the one or more embedding vectors as input to the linear layer.

### BRIEF DESCRIPTION OF THE DRAWINGS

FIG. 1 is a diagram of an example of a system with a framework for query tasks according to an example embodiment of this disclosure.

FIG. 2A illustrates one example of a transformer model according to an embodiment that may be utilized for manufacturing or assembly of products.

FIG. 2B illustrates one example of a transformer model according to an embodiment that may be utilized for manufacturing or assembly of products that emphasizes details related to a self-attention model.

FIG. 3 is an embodiment of a chart illustrating examples of instance-based sensitivity analysis.

FIG. 4 is an embodiment that illustrates graphs associated with the root cause pruning.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

In a production line, a part is processed by multiple sections in series. At each section, a part is processed and measured in multiple steps. At the end of the line, testing may be conducted of the quality of the manufactured part. If the part does not pass the end-of-line quality test, it may be crucial to identify root causes of such quality failures. For each part, there may be a long sequence of measurements collected from many steps at many sections, and the root cause could be any small subset of the large number of measurements.

Applying root cause analysis on the long sequence data directly may be difficult due to two reasons: (1) the long sequence data usually has complicated data patterns, and (2) the run-time of root cause analysis can increase dramatically with the increasing number of input features. To this end, one embodiment proposes to first build a model, parameterized by transformers, to model the complicated patterns of manufacturing data. Then, the system and method may use the trained transformer model with feature attribution methods to perform root-cause analysis or root-cause pruning. In root-cause analysis, the proposed method may predict the contribution score of each input feature to a target measurement. An input feature with a high absolute value of the contribution score may be important for predicting the target measurements. In root-cause pruning, the input features with high absolute contribution scores may be selected and given to the downstream applications, e.g., causal discovery, causal graph analysis. The running of downstream applications can be accelerated thanks to the pruned input feature space.

Beyond applying transformers for NLP tasks, the system may apply transformers with novel components (i.e., categorical/continuous input embeddings, section-dependent linear prediction heads) to model the sequential manufacturing data. The trained transformer model is able to predict the next section measurement values given upstream measurement values.

One embodiment may be utilized to show that the system and method may apply feature attribution methods, e.g., DeepLift, on the trained transformer for root-cause analysis. Benefiting from the trained transformer, one embodiment may illustrated that the proposed system and method may understand data patterns, including complicated data patterns. With the trained transformer, the feature attribution methods predict the contribution scores of input features to target measurements. The system and method may propose to use the contribution scores for root cause analysis. That embodiments illustrated that one may reduce the input feature search space with the contribution scores for downstream tasks, e.g., causal discovery, causal graph analysis.

Thus, the various embodiments can be used to find out important input features causing the target measurement value, e.g., the quality of a manufactured part. The learned transformer model can be used for root cause analysis and root cause pruning.

In one embodiment, the system and method may include training a transformer f to predict the measurements at the next section given upstream measurements. The transformer f may include input embeddings, positional embeddings, self-attention modules, and section-dependent linear prediction heads. Additional details are explained further below.

One embodiment may also include the application of feature attribution methods on transformers. Feature attribution methods may assign contribution scores to input features. The absolution values of contribution scores may reveal how much the input features contribute to predicting the target measurements. In one embodiment, the system and method may consider one feature attribution method, DeepLift as an example. Such an embodiment may also be compatible with other feature attribution methods. DeepLift is a gradient-based approach. The gradients of the model output respect to the inputs indicates the coefficients of a neural network. Therefore, the product of the gradient and the input feature value may be a good basis for developing feature attribution methods. DeepLift may compute a discrete gradient by backpropagating the difference of the model output to a baseline to the input features.

The embodiments disclosed below may involve two stages. During a first stage, given a set of sequence data, the system may train a transformer modeling the patterns of the data. The trained transformer model can predict the measurements at the next section given upstream measurements. The system may apply feature attribution methods such as, e.g. DeepLift, on the trained transformer model to predict the important scores for all input features with respect to any target measurements, e.g., the quality of a manufactured part. The important scores may be utilized and useful in root-cause analysis and root-cause pruning.

In a production line, the system may have a sequence of sections. A part is processed by T sections one by one. At each section, a part is processed in multiple steps. There may be a long sequence of measurements (including categorical measurements, e.g., the id number of the section, and continuous measurements, e.g., the width of the part) collected from many steps at many sections recording the status of the part and the status of the machine.

The system may apply feature attribution methods on the trained transformer for root cause analysis and root cause pruning. The proposed framework is compatible with various feature attribution methods. As an example, the system may apply DeepLift to the trained transformer. DeepLift is a gradient-based approach. It computes a discrete gradient by backpropagating the difference of the model output to a baseline to the input features.

The advantage of deep learning models is that they can find the highly relevant input nodes very fast, e. g, get the attributions for 100 samples in second. Their disadvantage is the RCA results given by deep learning models are less interpretable. Considering these, instead of using RCA results from deep learning model directly, the system and method can use these results to filter out irrelevant input nodes and obtain a much smaller directed acyclic graph as shown below, therefore accelerating the running of downstream white-box RCA methods.

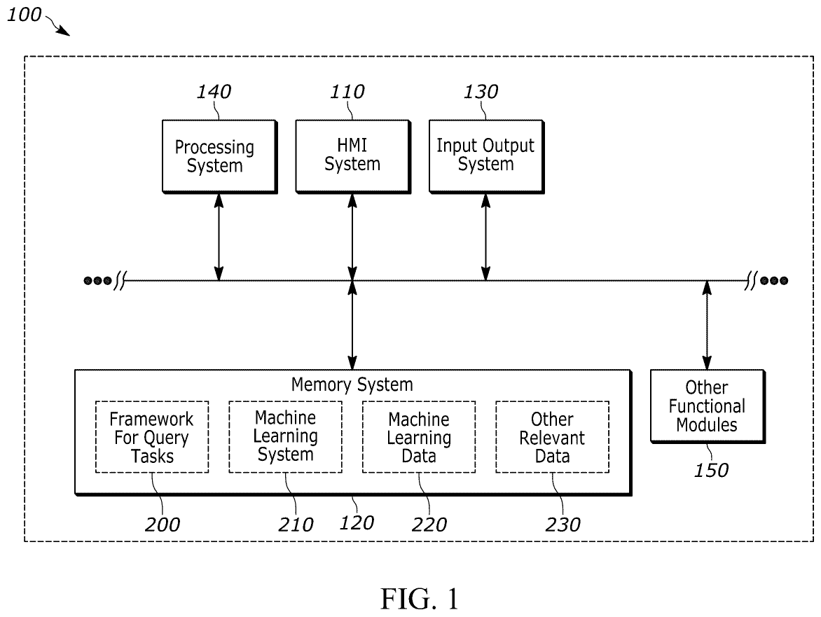

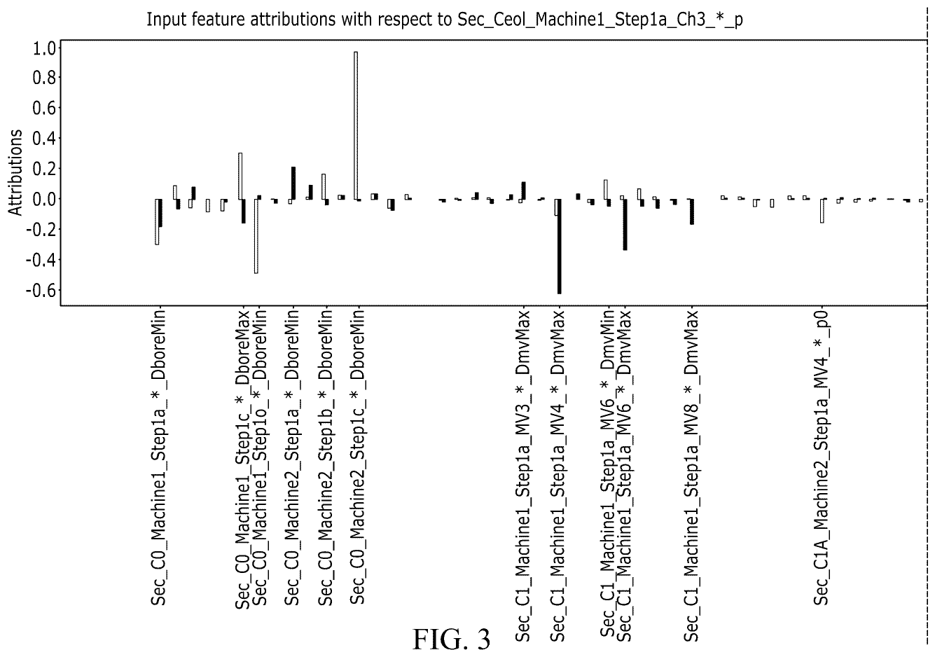

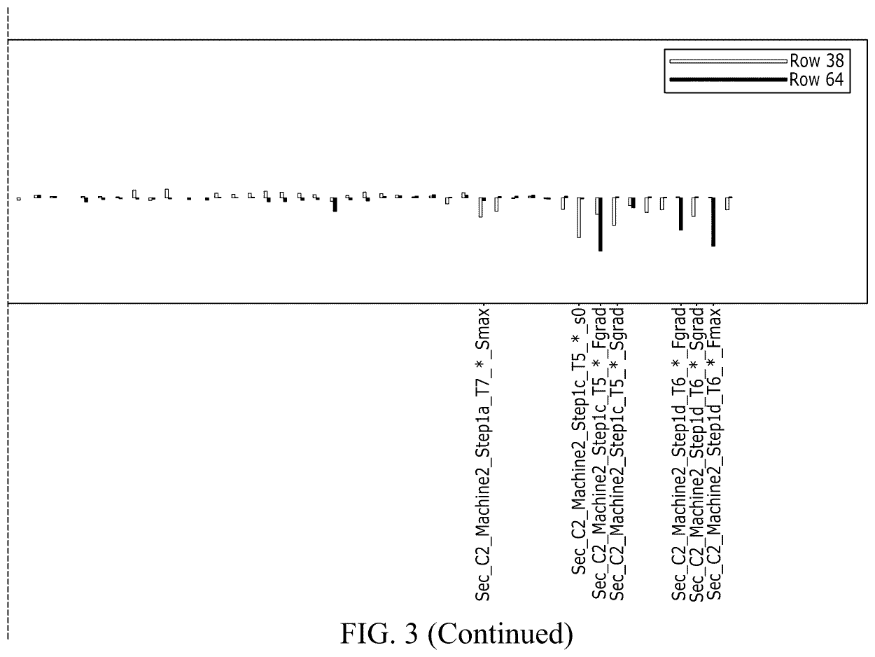

FIG. 1 is a diagram of an example of a system 100 with a neuro-symbolic framework 200 for query tasks according to an example embodiment. The system 100 is configured to pre-train (or train) the machine learning system 210 via the neuro-symbolic framework 200. In addition, the system 100 is an example of a system configured to perform on the machine learning system 210 via the framework 200. After undergoing pre-training (or both pre-training and zero-shot testing), the system 100 may be configured to employ the machine learning system 210 for use. Alternatively, the system 100 may be configured to enable the pre-trained (or pre-trained and zero-shot tested) machine learning system 210 to be employed and/or deployed in another system (e.g. system 300 of FIG. 3) for use.

The system 100 includes at least a processing system 140. The processing system 140 includes at least an electronic processor, a central processing unit (CPU), a graphics processing unit (GPU), a microprocessor, a field-programmable gate array (FPGA), an application-specific integrated circuit (ASIC), any suitable processing technology, or any number and combination thereof. The processing system 140 is operable to provide the functionality of the framework 200 and the machine learning system 210, as described herein.

The system 100 includes at least a memory system 120, which is operatively connected to the processing system 140. In an example embodiment, the memory system 120 includes at least one non-transitory computer readable medium, which is configured to store and provide access to various data to enable at least the processing system 140 to perform the operations and functionalities with respect to the framework 200 and corresponding machine learning system 210, as disclosed herein. In an example embodiment, the memory system 120 comprises a single computer readable storage device or a plurality of computer readable storage devices. The memory system 120 can include electrical, electronic, magnetic, optical, semiconductor, electromagnetic, or any suitable storage technology that is operable with the system 100. For instance, in an example embodiment, the memory system 120 can include random access memory (RAM), read only memory (ROM), flash memory, a disk drive, a memory card, an optical storage device, a magnetic storage device, a memory module, any suitable type of memory device, or any number and any combination thereof. With respect to the processing system 140 and/or other components of the system 100, the memory system 120 is local, remote, or a combination thereof (e.g., partly local and partly remote). For example, the memory system 120 can include at least a cloud-based storage system (e.g. cloud-based database system), which is remote from the processing system 140 and/or other components of the system 100.

The memory system 120 includes at least the framework 200, the machine learning system 210, machine learning data 220, and other relevant data 230, which are stored thereon and accessible therefrom. The framework 200 includes computer readable data that, when executed by the processing system 140, is configured to generate at least one training set with a suitable number of query tasks for the machine learning system 210. In addition, the framework 200 includes computer readable data that, when executed by the processing system 140, is configured to implement a zero-shot testing process (or a zero-shot evaluation process) to evaluate the pre-trained (or trained) machine learning system 210 with respect to various commonsense tasks. The computer readable data can include instructions, code, routines, various related data, any software technology, or any number and combination thereof.

In an example embodiment, the machine learning system 210 includes at least one machine learning model. More specifically, the machine learning system 210 includes at least one transformer model. For example, the machine learning system 210 includes a transformer mudel or any number of transformer models and combination thereof.

In an example embodiment, the machine learning data 220 includes various data, which the framework 200 uses to train, test, and develop the machine teaming system 210. For example, the machine learning data 220 includes a global knowledge graph 220A. The global knowledge graph 220A is generated by combining various knowledge graphs 220B. The machine learning data 220 may also include one or more knowledge bases, which are associated with one or more of the knowledge graphs 220B. The machine learning data 220 also includes a set of commonsense task datasets 220C, which cover a diverse set of tasks. In addition, the machine learning data 220 may also include various annotations, various loss data, various parameter data, as well as any related data that enables the neuro-symbolic framework 200 and the machine learning system 210 to perform the functions as described herein while meeting certain performance criteria. Meanwhile, the other relevant data 230 provides various data (e.g. operating system, etc.), which enables the system 100 to perform the functions as discussed herein.

In an example embodiment, as shown in FIG. 1, the system 100 is configured to include at least one human machine interface (HMI) system 110. The HMI system 110 includes at least one user interface, at least one HMI device, or any number of combination thereof. For example, the HMI system 110 may include a visual user interface, an auditory user interface, a tactile user interface, any suitable user interface, or any number and combination thereof. The HMI system 110 is operable to communicate with the I/O system 130. The HMI system 110 is also operable to communicate with one or more other components (e.g., processing system 140, memory system 120, etc.) of the system 100. More specifically, for example, the processing system 140 is configured to obtain or extract a query or a query task directly or indirectly from the HMI system 110, the memory system 120, and/or the I/O system 130. Upon receiving the query or query task, the processing system 140 is configured to provide a predicted answer to the query or query task via the machine learning system 210.

In addition, the system 100 includes other components that contribute to the training and/or execution of the framework 200 and the machine learning system 210. For example, as shown in FIG. 1, the memory system 120 is also configured to store other relevant data 230, which relates to operation of the system 100 in relation to one or more components (e.g., sensor system 110, I/O system 130, and other functional modules 150). In addition, the VO system 130 may include an VO interface and may include one or more devices (e.g., microphone, keyboard device, touch display device, microphone, mouse, speaker device, etc.). Also, the system 100 includes other functional modules 150, such as any appropriate hardware technology, software technology, or combination thereof that assist with or contribute to the functioning of the system 100. For example, the other functional modules 150 include communication technology that enables components of the system 100 to communicate with each other as described herein. Accordingly, with at least the components shown in FIG. 1, the system 100 is configured to execute the framework 200 to pre-train (or train) the machine learning system 210 to perform well across various query tasks (e.g. question-answering tasks) in a zero-shot setting or when deployed/employed for use in an application.

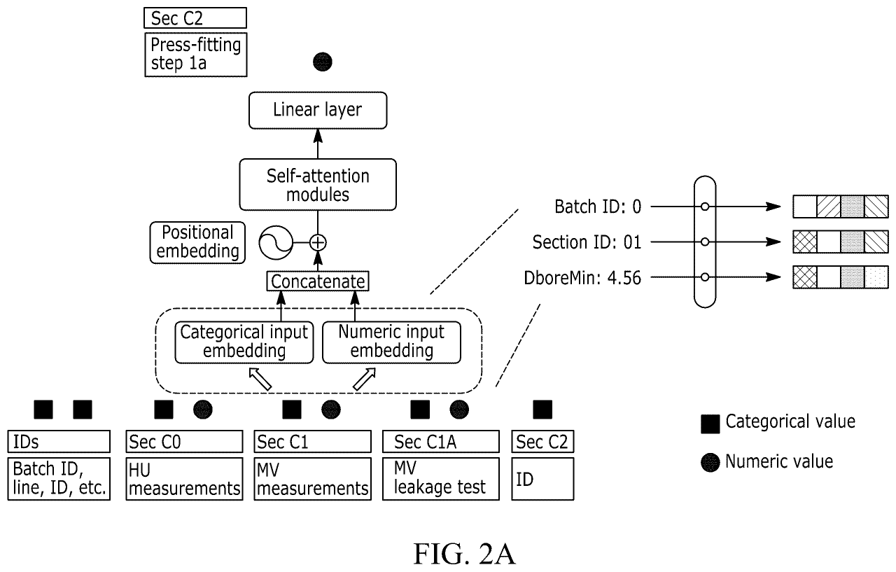

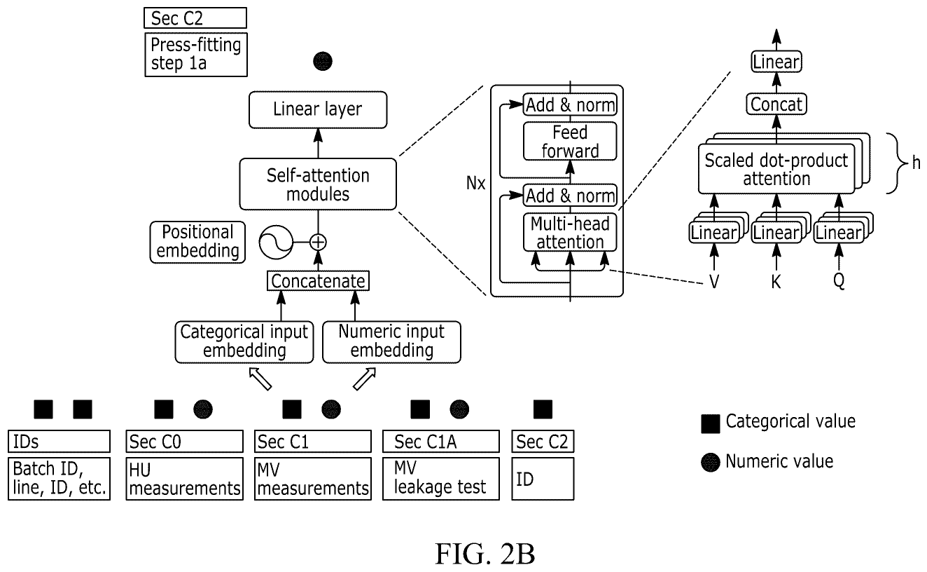

FIG. 2A illustrates one example of a transformer model according to an embodiment that may be utilized for manufacturing or assembly of products. FIG. 2B illustrates one example of a transformer model according to an embodiment that may be utilized for manufacturing or assembly of products that emphasizes details related to a self-attention model. The transformer f consists of sections 201a-201e that contain categorical input embeddings 203 and continuous input embeddings 205, positional embeddings 209, self-attention modules 211, and section-dependent linear prediction heads that are linear layers 213 of each section.

In one model, various stations associated with input embeddings 201a, 201b, 201c, 201d, 201e may be associated with different data. The various stations may be associated with a certain task or category. In one embodiment, a station 201a may include identifications, such as the batch ID or line ID. In another section 201b, the station may obtain handling unit (HU) measurements. In yet another section, station 201c may obtain magnetic values (MV) measurements. In station 201d, station may obtain values associated with magnetic value (MV) leakage test. In yet another embodiment, section 201e may include info associated with the ID.

Before feeding the measurement values to the self-attention modules 211, the system may embed the categorical values and continuous values to embedding vectors z∈IR^{d}. The system may continue embed continuous values with a learnable linear layer with the output dimension of d. Inspired by word2vec, the system may utilize a lookup table that stores learnable embedding vectors with the dimension of d for all categorical values. In summary, the upstream measurements x_{1:T} are first embedded to vectors z_{1:T}⁰.

The system may obtain the various measurements and values from the stations and generate corresponding categorical input embeddings 203 and a numeric input embeddings 205. Categorical input embeddings 203 may be derived utilizing a technique used in machine learning, particularly in natural language processing (NLP) and deep learning, to transform categorical data into a numerical format that can be used as input for machine learning models. In one embodiment, One-Hot Encoding may be utilized and each category may be represented as a binary vector, where only one element is “1” (indicating the presence of that category) and all other elements are “0.” This approach can lead to high-dimensional data, especially with a large number of categories. In another embodiment, label encoding may be utilized. In label encoding, each category may be assigned a unique integer value.

To enable the self-attention modules 211 to capture the sequence's order, it becomes necessary to incorporate information concerning the relative or absolute positions of the input features within the sequence. To achieve this, the system and method may add positional embeddings 209 to the embeddings z_{1:T}⁰ prior to entering the self-attention modules 211. The positional embeddings 209 may be a vector representing the position of the token in the sequence that is added to the token embedding. This helps the model distinguish between words based on their positions.

A shown in FIG. 2.B, the self-attention module may include of a multi-head attention layer 251 (with layer normalization) and a feed-forward network 255 composed of linear layers with GEGLU activations. The detailed calculation of multi-head attention 251 can be a component of the transformer model. The multi-head attention layer 251 may be utilized to enhance the model's ability to focus on different parts of the input sequence simultaneously. After passing through L self-attention modules the system get embedding vectors z_{1:T}^{L}. For each head, the attention may be computed as a Softmax function utilizing query vectors, key vectors, and value vectors. The attention score is calculated by taking the dot product of the Query with all the Keys, followed by a Softmax function to obtain weights. These weights may then used to sum up the value vectors, resulting in the attention output.

A linear layer is trained to predict the measurements x̅_̅{̅T̅+̅1̅:̅T̅+̅l̅}̅ at the next section taking the embedding z_{T}^{L} as the input. As the sections have varying numbers of measurements and different context. For each section, the system and method may learn one linear layer for prediction individually. The output dimension of the linear layer equals the number of measurements at the section. All parameters of the transformer are trained by minimizing the mean square error between the ground-truth measurement values and the model predicted measurement values.

FIG. 3 is an embodiment of a chart illustrating examples of instance-based sensitivity analysis. As shown in FIG. 3, the system and method may obtain the contribution scores of all input features for predicting the target measurement as shown. The absolution values of contribution scores may reveal how much the input features contribute to the model prediction. An input feature with a high absolute value of the contribution score is likely to be the root cause of the target measurements. Thus, for example, FIG. 3 illustrates that a value of approximately 1.0 may illustrate a root cause issue. Thus, an identification of certain section or step may be identified as the issue associated with the root cause issue.

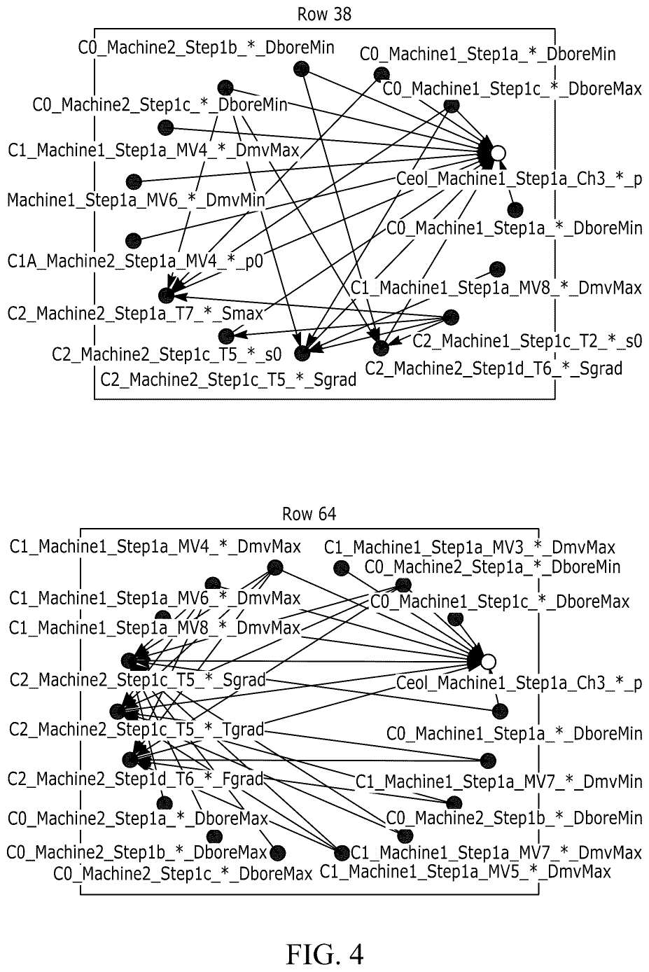

FIG. 4 is an embodiment that illustrates graphs associated with the root cause pruning. The charts may be directed to acyclic graphs with pruned nodes and edges. One embodiment may include row 38 and row 64. After the pruning, the graphs may illustrate a target step and previous manufacturing steps that are connected to the final target step. In one embodiment, the system may output the various graphs. The system may be able to establish a root cause issue associated with the visual characteristics of the graph.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method of utilizing a transformer model to perform root cause analysis on a manufacturing process, the method comprising:
providing a pre-trained transformer model that is trained to predict measurements of non-faulty parts;
receiving, from the plurality of sensors at the plurality of manufacturing stations, a first set of measurement data regarding physical characteristics of a first plurality of manufactured parts and an identification of a plurality of manufacturing stations;
obtaining one or more categorical embeddings and a numerical embeddings associated with the first set of measurement data;
concatenating one or more positional embeddings with the categorical embedding and the numerical embedding associated with the first set of measurement data to generate a concatenation associated with the first set of measurement data;
outputting one or more embedding vectors in response to passing the utilizing the concatenation associated with the first set of measurement data at a self-attention module that includes a multi-head attention layer; and
outputting a prediction associated with a second utilizing a linear layer of the pre-trained transformer model and the one or more embedding vectors as input to the linear layer.

2. The method of claim 1, wherein the method further includes obtaining a contribution score associated with the first set of measurement data by computing a discrete gradient by backpropagation a difference of the transformer model output to a baseline of associated with input features.

3. The method of claim 1, wherein the categorical input embedding is derived utilizing a one-hot encoding including a binary vector.

4. The method of claim 1, wherein the linear layer is trained to predict one or more measurements at a next station.

5. The method of claim 4, wherein the one or more embedding vectors includes a time stamp associated with a sequence.

6. The method of claim 1, wherein the self-attention module includes a feed forward network and a multi-head attention layer.

7. The method of claim 1, wherein the plurality of sensors includes image sensors or laser measurement sensors.

8. A computer-implemented method of utilizing a pre-trained machine learning model to perform root cause analysis on a manufacturing process, the method comprising:
providing a pre-trained transformer model that is trained to predict measurements of non-faulty parts;
receiving, from the plurality of sensors at the plurality of manufacturing stations, a first set of measurement data regarding physical characteristics of a first plurality of manufactured parts and an identification of a plurality of manufacturing stations;
for each of the plurality of manufacturing stations, the method further including:
obtaining one or more categorical embeddings and one or more numerical embeddings associated with the first set of measurement data;
concatenating one or more positional embeddings with the categorical embedding and the numerical embedding associated with the first set of measurement data to generate a concatenation associated with the first set of measurement data;
outputting one or more embedding vectors in response to passing the utilizing the concatenation associated with the first set of measurement data at a self-attention module that includes a multi-head attention layer;
outputting a prediction associated with a second utilizing a linear layer of the pre-trained transformer model and the one or more embedding vectors as input to the linear layer; and
outputting a contribution score associated with the first set of measurement data by computing a discrete gradient by backpropagation a difference of the linear layer output to a baseline of associated with input features.

9. The method of claim 8, wherein an output dimension of the linear layer is equal to a number of measurements at the station.

10. The method of claim 8, wherein each of the plurality of stations includes a long sequence of measurements associated with each station.

11. The method of claim 8, wherein the self-attention module includes a feed forward network and a multi-head attention layer, wherein the feed forward network includes a Generalized Gaussian Linear Unit (GEGLU) activation.

12. The method of claim 8, wherein the method further includes obtaining a contribution score associated with the first set of measurement data by computing a discrete gradient by backpropagation a difference of the linear layer output to a baseline of associated with input features.

13. The method of claim 8, wherein the plurality of sensors includes image sensors or laser measurement sensors.

14. A computer-implemented method of utilizing a machine learning model to perform root cause analysis to determine a part type causing a fault within a manufacturing setting, the method comprising:
providing a transformer model that is trained to predict measurements of non-faulty parts;
receiving, from the plurality of sensors at the plurality of manufacturing stations, a first set of measurement data regarding physical characteristics of a first plurality of manufactured parts and an identification of a plurality of manufacturing stations;
obtaining one or more categorical embeddings and numerical embeddings associated with the first set of measurement data;
concatenating one or more positional embeddings with the categorical embedding and the numerical embedding associated with the first set of measurement data to generate a concatenation associated with the first set of measurement data;
outputting one or more embedding vectors in response to passing the utilizing the concatenation associated with the first set of measurement data at a self-attention module that includes a multi-head attention layer; and
outputting a prediction associated with a second utilizing a linear layer of the pre-trained transformer model and the one or more embedding vectors as input to the linear layer.

15. The method of claim 14, wherein an output dimension of the linear layer is equal to a number of measurements at the station.

16. The method of claim 14, wherein the self-attention module includes a feed forward network and a multi-head attention layer, wherein the feed forward network includes a Generalized Gaussian Linear Unit (GEGLU) activation.

17. The method of claim 14, wherein the categorical input embedding is a binary vector.

18. The method of claim 17, wherein the transformer model is a pre-trained transformer model.

20. The method of claim 14, wherein the transformer model utilizes a lookup table that stores learnable embedding vectors with a dimension for all categorical values.
